(19) United States
(12) Patent Application Publication
(10) Pub. No.: US 2022/0294350 A1
(43) Pub. Date: Sep. 15, 2022

(54) SWITCHING POWER SUPPLY

(71) Applicant: ROHM CO., LTD., Kyoto-shi (JP)

(72) Inventor: Shinya KARASAWA, Kyoto-shi (JP)

(21) Appl. No.: 17/824,005

(22) Filed: May 25, 2022

Related U.S. Application Data
(63) Continuation of application No. PCT/JP2020/042992, filed on Nov. 18, 2020.

(30) Foreign Application Priority Data
Nov. 26, 2019 (JP) 2019-213529

(51) Int. Cl. H02M 3/158; H02M 1/00

(52) U.S. Cl. CPC H02M 3/158; H02M 1/0003

(57) ABSTRACT

An error detector generates an error signal that corresponds to an error between a feedback signal based on an output of a switching power supply and a target value thereof. A compensator generates a control instruction such that the error signal approaches zero. A pulse modulator generates a pulse signal that corresponds to the control instruction. An auto-tuner automatically optimizes a parameter that defines a response characteristic of the compensator. A degradation estimator generates information with respect to the degradation of an output capacitor of the switching power supply based on the parameter thus automatically optimized.

### CROSS REFERENCE TO RELATED APPLICATIONS

This application is a continuation under 35 U.S.C. § 120 of PCT/JP2020/042992, filed Nov. 18, 2020, which is incorporated herein by reference, and which claimed priority to Japanese Application No. 2019-213529, filed Nov. 26, 2019. The present application likewise claims priority under 35 U.S.C. § 119 to Japanese Application No. 2019-213529, filed Nov. 26, 2019, the entire content of which is also incorporated herein by reference.

### BACKGROUND

### Technical Field

The present disclosure relates to a switching power supply.

### Description of the Related Art

In order to generate a voltage that is higher or lower than a supplied input voltage, a power supply circuit such as a DC/DC converter (switching regulator) or the like is employed. As such power supply circuits, circuits with analog control and digital control are known. In power supply circuits with analog control, the difference between the output voltage of the power supply circuit and the target value thereof is amplified by an error amplifier, and the switching duty ratio is controlled according to the output of the error amplifier, so as to stabilize the output voltage to the target value. In power supply circuits with digital control, the output voltage of the power supply circuit is converted into a digital value by an A/D converter, and the duty ratio of the switching transistor is controlled by digital signal processing.

An output line of the DC/DC converter is provided with a large-capacitance smoothing capacitor arranged in parallel with a load. In many cases, as the smoothing capacitor, an aluminum electrolytic capacitor is employed. However, such an aluminum electrolytic capacitor has a problem in that the capacitance value decreases due to long-term use, leading to the occurrence of an abnormality in the power supply circuit.

Typically, this requires a power supply manufacturer or a device manufacturer to replace a power supply board or replace it with a new device in a cycle that is shorter than the estimated operating life, leading to increased maintenance costs. In infrastructure such as servers, base stations, etc., such a power supply circuit is not allowed to stop operating. Accordingly, there is a need to determine the cycle of the component replacement to be significantly shorter than the actual operating life of the component in view of safety.

If the power supply circuit itself is capable of estimating the degradation of the smoothing capacitor, such an arrangement is not required to shorten the replacement cycle beyond what is necessary. This is capable of suppressing maintenance costs.

### SUMMARY

An embodiment of the present disclosure has been made in order to solve such a problem.

An embodiment according to the present disclosure relates to a control circuit for a switching power supply. The control circuit includes: an error detector structured to generate an error signal that corresponds to an error (deviation) between a feedback signal based on an output of the switching power supply and a target value thereof; a compensator structured to generate a control instruction such that the error signal approaches zero; a pulse modulator structured to generate a pulse signal that corresponds to the control instruction; an auto-tuner structured to automatically optimize a parameter that defines a response characteristic of the compensator; and a degradation estimator structured to generate information with respect to degradation of an output capacitor of the switching power supply based on the parameter thus automatically optimized.

It is to be noted that any arbitrary combination or rearrangement of the above-described structural components and so forth is effective as and encompassed by the present embodiments. Moreover, all of the features described in this summary are not necessarily required by embodiments so that the embodiment may also be a sub-combination of these described features. In addition, embodiments may have other features not described above.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a switching power supply according to an embodiment.

FIG. 2 is a circuit diagram of a step-down converter.

FIG. 3 is a diagram showing the gain characteristics and the phase characteristics of a step-down converter.

FIG. 4 is a block diagram showing an example configuration of a compensator.

FIG. 5 is a diagram showing a dependence of the gain characteristics of the compensator shown in FIG. 4 with respect to a coefficient α.

FIG. 6A is a diagram showing the loop characteristics (simulation results) in a case in which the parameter is not automatically optimized, and FIG. 6B is a diagram showing the loop characteristics (simulation results) in a case in which the parameter is automatically optimized.

FIG. 7 is a block diagram showing a part of the control circuit.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

One embodiment relates to a control circuit for a switching power supply. The control circuit includes: an error detector structured to generate an error signal that corresponds to an error (deviation) between a feedback signal based on an output of the switching power supply and a target value thereof; a compensator structured to generate a control instruction such that the error signal approaches zero; a pulse modulator structured to generate a pulse signal that corresponds to the control instruction; an auto-tuner structured to automatically optimize a parameter that defines a response characteristic of the compensator; and a degradation estimator structured to generate information with respect to degradation of an output capacitor of the switching power supply based on the parameter thus automatically optimized.

The control target (Plant) included in the switching power supply has filter characteristics. The filter characteristics vary according to the degradation of the output capacitor. The response characteristics of the compensator are automatically optimized such that they match the filter characteristics of the control target. Accordingly, the parameter of the compensator has a correlation with the filter characteristics. This allows the degradation of the output capacitor to be estimated based on the parameter thus acquired by the automatic optimization. Furthermore, the automatic optimization processing of the compensator also serves as the degradation estimation. This has an advantage of requiring minimal additional hardware or processing for degradation estimation.

In one embodiment, the compensator may include: a first compensator having first characteristics, and structured to generate a first control instruction H₁ based on the error signal; a second compensator having second characteristics, and structured to generate a second control instruction H₀ based on the error signal; and an adder structured to calculate a weighted addition of the first control instruction H₁ and the second control instruction H₀, so as to generate the control instruction H represented by H=α×H₁+(1−α)×H₀. Also, the parameter may be a weighting coefficient for the adder.

In one embodiment, with a variation range of an effective capacitance value of the output capacitor as ΔCeff, and with a variation range from an initial value of the coefficient α as Δα, the degradation estimator may execute calculation based on ΔCeff=(Δα)².

In one embodiment, the control circuit may further include an interface circuit for communicating with an external controller. Also, the interface circuit may receive the initial value of α.

In one embodiment, the control circuit may further include an interface circuit for communicating with an external controller. Also, the interface circuit may be structured to be capable of outputting information with respect to the variation range ΔC to an external circuit.

In one embodiment, the control circuit may further include an interface circuit for communicating with an external controller. When the variation range ΔC exceeds a predetermined threshold value, the degradation estimator may assert an error flag. Also, the interface circuit may receive the threshold value.

In one embodiment, the control circuit may be monolithically integrated on a single semiconductor substrate. Examples of such an “integrated” arrangement include: an arrangement in which all the circuit components are formed on a semiconductor substrate; and an arrangement in which principal circuit components are monolithically integrated. Also, a part of resistors or capacitors may be arranged in the form of components external to such a semiconductor substrate in order to adjust the circuit constants. By integrating the circuit on a single chip, such an arrangement allows the circuit area to be reduced and allows the circuit elements to have uniform characteristics.

### Embodiments

Description will be made below regarding the present disclosure based on preferred embodiments with reference to the drawings. The same or similar components, members, and processes shown in each drawing are denoted by the same reference numerals, and redundant description thereof will be omitted as appropriate. The embodiments have been described for exemplary purposes only and are by no means intended to restrict the present disclosure. Also, it is not necessarily essential for the present disclosure that all the features or a combination thereof be provided as described in the embodiments.

In the present specification, the state represented by the phrase “the member A is coupled to the member B” includes a state in which the member A is indirectly coupled to the member B via another member that does not substantially affect the electric connection between them, or that does not damage the functions or effects of the connection between them, in addition to a state in which they are physically and directly coupled.

Similarly, the state represented by the phrase “the member C is provided between the member A and the member B” includes a state in which the member A is indirectly coupled to the member C, or the member B is indirectly coupled to the member C via another member that does not substantially affect the electric connection between them, or that does not damage the functions or effects of the connection between them, in addition to a state in which they are directly coupled.

In the present specification, the reference symbols denoting electric signals such as a voltage signal, current signal, or the like, and the reference symbols denoting circuit elements such as a resistor, capacitor, or the like, also represent the corresponding voltage value, current value, resistance value, or capacitance value as necessary.

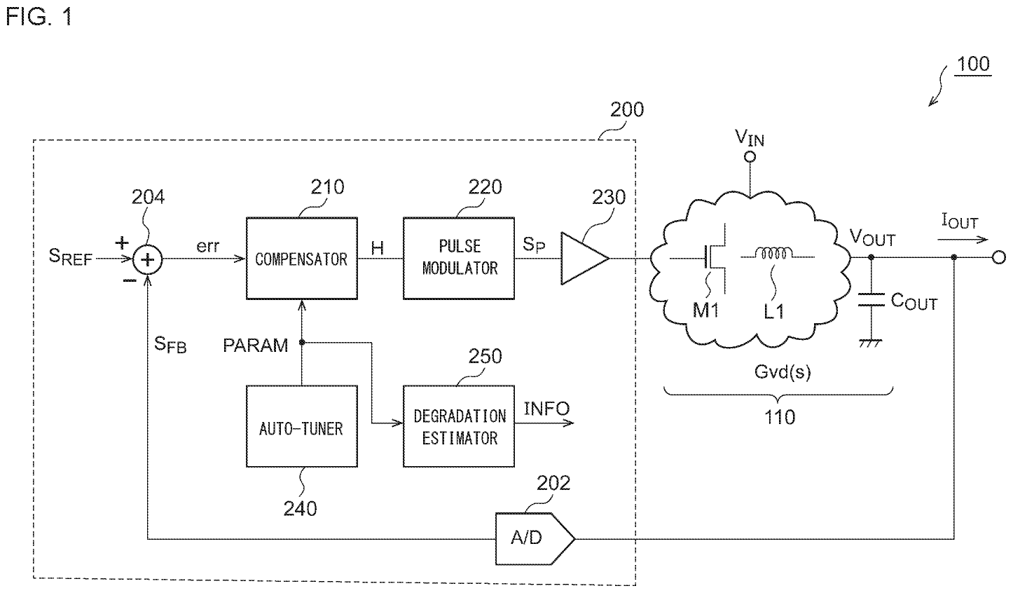

FIG. 1 is a circuit diagram showing a switching power supply (switched-mode power supply) 100 according to an embodiment. Examples of the switching power supply 100 include step-up DC/DC converters, step-down DC/DC converters, step-up/step-down DC/DC converters, flyback converters, forward converters, Power Factor Correction (PFC) circuits, etc. Also, the switching power supply 100 may be configured as an insulated circuit or a non-insulated circuit.

The switching power supply 100 includes a control circuit 200 and an output circuit 110. The output circuit 110 includes multiple circuit components such as a smoothing output capacitor C_{OUT}, an inductor (reactor) L1, a switching element M1, a rectifier element, etc. Various topologies may be employed for the output circuit 110 according to the kind of the switching power supply 100.

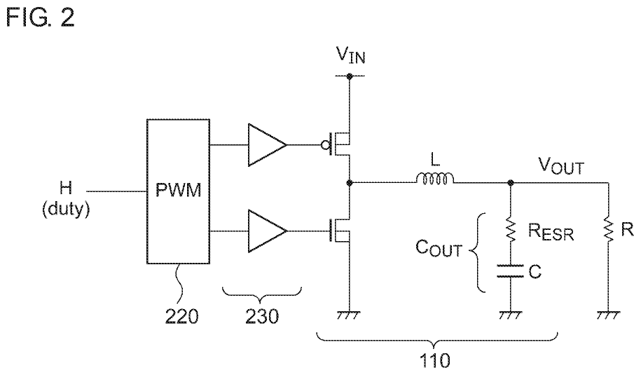

The control circuit 200 includes an A/D converter 202, an error detector 204, a compensator 210, a pulse modulator 220, a driver 230, an auto-tuner 240, and a degradation estimator 250, which are integrated as an Integrated Circuit (IC) on a single semiconductor substrate. It should be noted that the switching element M1 (M1 and M2 shown in FIG. 2) included in the output circuit 110 shown in FIG. 1 may be integrated in the control circuit 200.

A signal that corresponds to the output of the switching power supply 100 is fed back to the control circuit 200. For example, as the output of the switching power supply 100, the output voltage V_{OUT} may be employed (voltage mode). Also, the output current I_{OUT} may be employed as the output of the switching power supply 100 (current mode).

The A/D converter 202 converts a signal thus fed back into a digital feedback signal S_{FB}.

The error detector 204 generates an error signal err that corresponds to an error (deviation) between the feedback signal S_{FB} based on the output of the switching power supply 100 and a target value S_{REF} thereof. The compensator 210 generates the control instruction H such that the error signal err approaches zero. The compensator 210 is configured based on a circuit configuration of the output circuit 110 to be controlled. Typically, a proportional, integral, and differential (PID) controller may be employed.

The pulse modulator 220 generates a pulse signal Sp based on the control instruction H. At least one of the duty ratio, frequency, on time, and off time, of the pulse signal Sp or a combination thereof is changed according to the control instruction H.

The driver 230 drives the switching element M1 of the output circuit 110 based on the pulse signal Sp generated by the pulse modulator 220.

Description will be made regarding an example in which the switching power supply 100 is configured as a step-down converter (Buck converter). FIG. 2 is a circuit diagram of the step-down converter. The transfer function of the voltage mode of the step-down converter, which is a control target (Plant) to be controlled by the control circuit 200, is the same as that of an LC low-pass filter. The transfer function is represented by the following Expression (1). The input of the transfer function is the duty ratio Duty to be used as the control instruction H. Here, “R” represents the load resistance, “R_{ESR}” represents an equivalent series resistance of the output capacitor C_{OUT}, and “C” represents the capacitance of the output capacitor C_{OUT}.

[Expression 1]

As can be understood from Expression (1), as the capacitance value C of the output capacitor C_{OUT} becomes smaller, or as ESR becomes larger, the gain of the step-down converter becomes larger by ΔCeff/Ceff in the high-frequency range, i.e., the frequency bandwidth is extended.

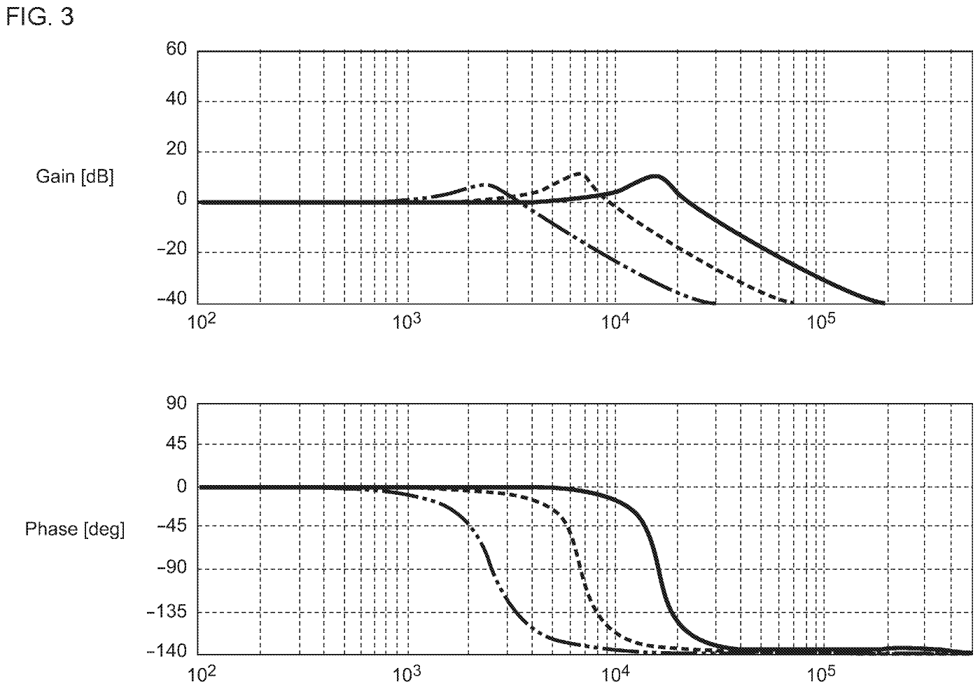

The constants of the circuit components (C, L) of the output circuit 110 externally coupled to the control circuit 200 vary for every user and for every end product. Accordingly, various transfer functions are employed for representing a target to be controlled. FIG. 3 is a diagram showing the gain characteristics and phase characteristics of a step-down converter. The transfer function Gv(s) of the step-down converter varies according to a combination of the capacitance value and ESR of the output capacitor and inductor.

Returning to FIG. 1, the characteristics Gc(z) of the compensator 210 are required to be designed giving consideration to load regulation, line regulation, transient response, stability margin, etc. Such characteristics are significantly affected by the transfer function Gv(s) of the target to be controlled. The auto-tuner 240 adaptively and automatically optimizes a parameter PARAM that defines the response characteristics of the compensator 210 according to the transfer function Gv(s) of the actual control target to be combined with the control circuit 200. As the parameter PARAM, one or multiple items may be employed from among proportional gain, integral gain, and derivative gain. Alternatively, the parameter PARAM may be configured as a coefficient or a variable having an effect on one or multiple items from among proportional gain, integral gain, and derivative gain.

The optimization processing for the parameter PARAM is executed at least once before the beginning of use of the end product. Furthermore, in a case in which the switching power supply 100 is to be used for a long period of time, the constant (C or ESR) of the output capacitor C_{OUT} changes due to aging degradation. Accordingly, the transfer function of the control target changes with time. In order to follow the aging variation of the transfer function of the control target, the control circuit 200 always, periodically, or irregularly operates the auto-tuner 240 so as to update the parameter PARAM even after shipping.

The degradation estimator 250 generates information INFO with respect to degradation of the output capacitor C_{OUT} of the switching power supply 100 based on the parameter PARAM automatically optimized by the auto-tuner 240. Examples of the information INFO with respect to degradation include: (i) an amount of change ΔC from the initial state of the output capacitor C_{OUT}; (ii) the amount of change ΔC exceeds an allowed value, or in other words, a flag that indicates the end of the operating life of the output capacitor C_{OUT}; and (iii) an estimated value of the output capacitor C_{OUT}.

The above is the configuration of the switching power supply 100. The transfer function of the control target (Plant) included in the switching power supply 100 is represented by Gvd(s) in Expression (1) and has LC filter characteristics. The filter characteristics change with the degradation of the output capacitor C_{OUT}. Specifically, the filter characteristics change with a decrease of the effective capacitance value C and an increase of ESR.

With the switching power supply 100 shown in FIG. 1, the response characteristics (transfer function Gc(z)) of the compensator 210 are automatically optimized to match the filter characteristics Gvd(s) of the control target. Accordingly, the parameter PARAM for the compensator 210 acquired by the auto-tuner 240 has a correlation with the filter characteristics Gvd(s). This allows the degradation estimator 250 to estimate the degradation of the output capacitor C_{OUT} based on the parameter PARAM acquired by the automatic optimization.

Furthermore, the automatic optimization processing of the compensator 210 by the auto-tuner 240 also serves as the greater part of the degradation estimation processing. This has an advantage of requiring minimal additional hardware or processing for degradation estimation.

The present disclosure encompasses various kinds of apparatuses and methods that can be regarded as a block configuration or circuit configuration shown in FIG. 1, or otherwise that can be derived from the aforementioned description. That is to say, the present disclosure is not restricted to a specific configuration. More specific description will be made below regarding example configurations or examples for clarification and ease of understanding of the essence of the present disclosure and the operation thereof. That is to say, the following description will by no means be intended to restrict the technical scope of the present disclosure.

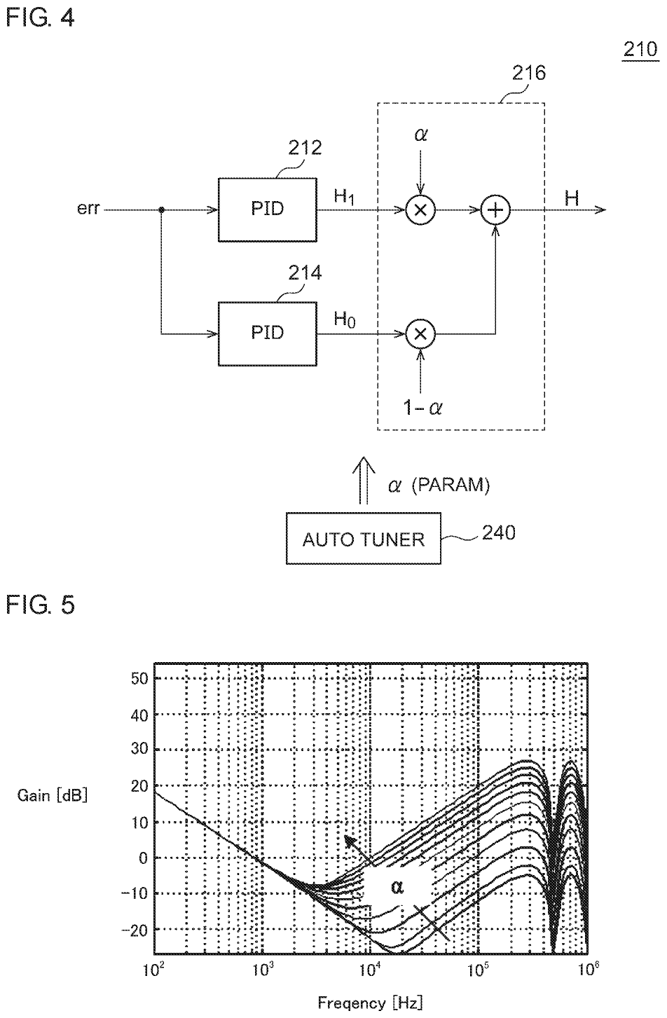

FIG. 4 is a block diagram showing an example configuration of the compensator 210. The compensator 210 includes a first compensator 212 and a second compensator 214 having different response characteristics. The first compensator 212 has first characteristics and generates a first control instruction H₁ based on the error signal err. The second compensator 214 has second characteristics that differ from the first characteristics and generates a second control instruction H₀ based on the error signal err.

The first compensator 212 and the second compensator 214 are designed such that they are optimized for different states of the transfer function Gvd(s) to be controlled. For example, the parameters (P, I, D gains) of the first compensator 212 are designed such that they are optimized for a state in which the inductor L and the capacitor C each have a minimum value in their respective assumed ranges. The parameters (P, I, D gains) of the second compensator 214 are designed such that they are optimized for a state in which the inductor L and the capacitor C each have a maximum value in their respective assumed ranges.

An adder 216 calculates weighted addition of the first control instruction H₁ and the second control instruction H₀ based on the following Expression (2), so as to generate a control instruction H. Here, “α” represents a coefficient that is changed in a range of 0 to 1.

H=α×H₁+(1−α)×H₀ (2)

With the compensator 210 shown in FIG. 4, the weighting coefficient α to be used in the adder 216 can be regarded as a parameter PARAM to be controlled for automatic adjustment. As the method for optimizing the coefficient α, a method described in U.S. Pat. No. 8,644,962 B2 may be employed, for example. This allows the auto-tuner 240 to maintain the coefficient α at its optimum value while stabilizing the output voltage V_{OUT} in the operation of the DC/DC converter.

FIG. 5 is a diagram showing the dependence of the gain characteristics of the compensator 210 shown in FIG. 4 with respect to the coefficient α. The coefficient α has no effect on the gain characteristics of the compensator 210 in the low-frequency range. The coefficient α is a parameter that changes the gain in the high-frequency range.

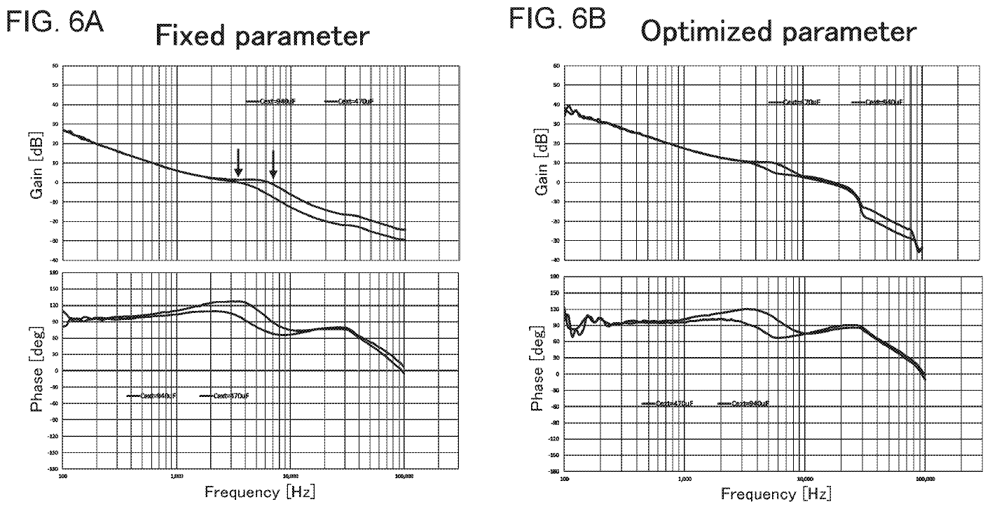

FIG. 6A is a diagram showing loop characteristics (simulation results) in a case in which the parameter is not automatically optimized. FIG. 6B is a diagram showing loop characteristics (simulation results) in a case in which the parameter is automatically optimized. In FIG. 6A and FIG. 6B, (i) the loop characteristics in a case in which the output capacitor C_{OUT} has a capacitance of 170 μF and 940 μF and (ii) the loop characteristics in a case in which the output capacitor C_{OUT} has a capacitance of 170 μF and 470 μF are plotted.

As shown in FIG. 6A, in a case in which the response characteristics of the compensator 210 are fixed (in this example, a is fixedly set to 0.643), the frequency bandwidth varies according to the capacitance value of the output capacitor C_{OUT}. Specifically, as the output capacitor C_{OUT} becomes larger, the frequency bandwidth becomes narrower. Conversely, as the output capacitor C_{OUT} becomes smaller, the frequency bandwidth becomes wider.

In contrast, with such an arrangement as shown in FIG. 6B in which the parameter a of the compensator 210 is automatically optimized, this allows the frequency bandwidth to be maintained at a constant level regardless of the capacitance value of the output capacitor C_{OUT}. This is because, as can be understood from Expression (1), a decrease of the capacitance value C of the output capacitor C_{OUT} or an increase of ESR thereof leads to an increase of the gain in the high-frequency range, i.e., an increase of the frequency bandwidth, of the control target that can be regarded as an LC filter. On the other hand, the parameter a allows the gain of the compensator 210 to be changed in the high-frequency range. Accordingly, by reducing the parameter a so as to offset an increase of the frequency bandwidth of the transfer function of the control target so as to lower the gain of the compensator 210 in the high-frequency range, this allows the frequency bandwidth of the loop gain to be maintained.

With the variation range of the effective capacitance value Ceff of the output capacitor C_{OUT} as ΔCeff, and with the variation range of the coefficient α from its initial value α₀ as Δα, the following relation holds true.

ΔCeff∝(Δα)² (3)

Accordingly, the degradation estimator 250 may calculate the variation range ΔCeff of the effective capacitance value of the output capacitor C_{OUT} based on the following Expression (4).

ΔCeff=(Δα)² (4)

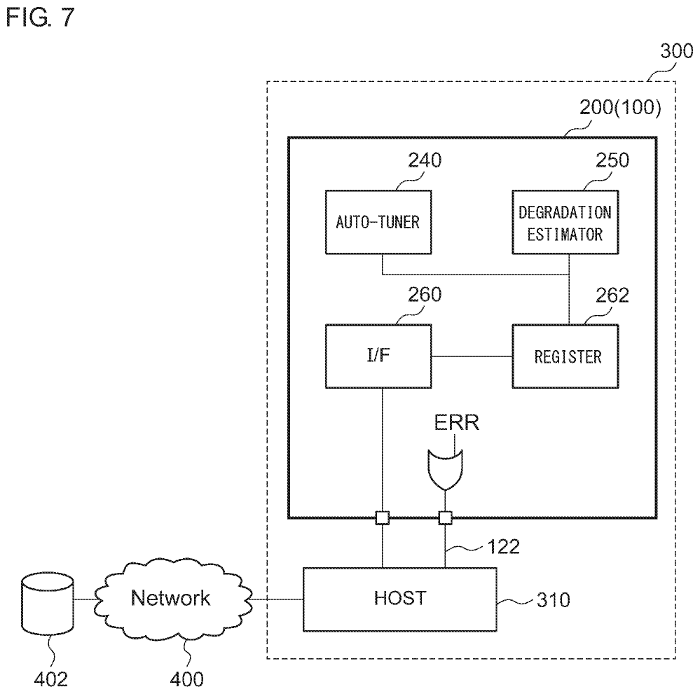

FIG. 7 is a block diagram showing an apparatus 300 provided with the switching power supply 100. The switching power supply 100 is employed in an apparatus 300 such as a server, mobile communication base station, or the like, which are required to operate for a long period of time. In addition to the switching power supply 100, the apparatus 300 is provided with a host controller 310 such as a microcontroller, CPU (Central Processing Unit), or the like.

The control circuit 200 is provided with an interface circuit 260. The control circuit 200 is capable of communicating with an external host controller 310 using the interface circuit 260. The protocol of the interface is not restricted in particular. For example, the Inter IC (I²C) or Serial Peripheral Interface (SPI) may be employed.

In an example, the interface circuit 260 may receive the initial value α₀ of the coefficient α from the host controller 310. The degradation estimator 250 may calculate the variation range ΔCeff of the output capacitor C_{OUT} based on the difference Δα (=|α−α₀|) between the optimized parameter a and the initial value α₀ thus received.

In an example, the interface circuit 260 may be capable of outputting information with respect to the variation range ΔC to an external circuit. In a case of employing I²C or SPI, the information with respect to the variation range ΔC may be stored at a predetermined address ADR1 in a register 262 of the control circuit 200. The host controller 310 may read out the address ADR1 using a read command so as to transmit the information with respect to the variation range ΔC to the host controller 310.

In an example, when the variation range ΔC exceeds a predetermined threshold value ACTH, the degradation estimator 250 may assert an error flag ERR. The error flag ERR may be stored at a predetermined address ADR2 in the register 262. The host controller 310 may read out the address ADR2 using a read command, so as to transmit the error flag ERR to the host controller 310. It should be noted that the threshold value ACTH may also be transmitted from the host controller 310 to the interface circuit 260.

In an example, when the variation range of the parameter PARAM (e.g., the coefficient α) from its initial value exceeds a predetermined threshold value, the degradation estimator 250 may assert the error flag ERR.

Also, the control circuit 200 and the host controller 310 may be coupled via an interrupt line 122. When a predetermined event such as assertion of the error flag ERR or the like occurs, the control circuit 200 may notify the host controller 310 using the interrupt line 122.

The host controller 310 is coupled to an external management terminal 402 via a wired or wireless network 400. The host controller 310 is configured to be capable of transmitting the information received from the control circuit 200 to the management terminal 402. When the management terminal 402 receives an alert that indicates the end of the operating life of the switching power supply 100, a service person is able to go to the installation site of the apparatus 300 to replace the switching power supply 100.

Description has been made regarding the present disclosure with reference to the embodiments using specific terms. However, the above-described embodiments show only an aspect of the mechanisms and applications of the present disclosure for exemplary purposes only and are by no means intended to be interpreted restrictively. Rather, various modifications and various changes in the layout can be made without departing from the spirit and scope of the present disclosure defined in appended claims.

What is claimed is:

1. A control circuit for a switching power supply, comprising:
an error detector structured to generate an error signal that corresponds to an error between a feedback signal based on an output of the switching power supply and a target value thereof,
a compensator structured to generate a control instruction such that the error signal approaches zero,
a pulse modulator structured to generate a pulse signal that corresponds to the control instruction,
an auto-tuner structured to automatically optimize a parameter that defines a response characteristic of the compensator; and
a degradation estimator structured to generate information with respect to degradation of an output capacitor of the switching power supply based on the parameter thus automatically optimized.

2. The control circuit according to claim 1, wherein the compensator comprises:
a first compensator having first characteristics, and structured to generate a first control instruction H₁ based on the error signal,
a second compensator having second characteristics, and structured to generate a second control instruction H₀ based on the error signal; and
an adder structured to calculate a weighted addition of the first control instruction H₁ and the second control instruction H₀, so as to generate the control instruction H represented by H=α×H₁+(1−α)×H₀,
and wherein the parameter is a weighting coefficient for the adder.

3. The control circuit according to claim 2, wherein, with a variation range of a capacitance value of the output capacitor as ΔC, and with a variation range from an initial value of the coefficient α as Δα, the degradation estimator executes calculation based on ΔC=(Δα)².

4. The control circuit according to claim 3, further comprising an interface circuit for communicating with an external controller,
wherein the interface circuit receives the initial value of α.

5. The control circuit according to claim 3, further comprising an interface circuit for communicating with an external controller,
wherein the interface circuit is structured to be capable of outputting information with respect to the variation range ΔC to an external circuit.

6. The control circuit according to claim 3, further comprising an interface circuit for communicating with an external controller,
wherein, when the variation range ΔC exceeds a predetermined threshold value, the degradation estimator asserts an error flag,
and wherein the interface circuit receives the threshold value.

7. The control circuit according to claim 1, monolithically integrated on a single semiconductor substrate.

8. A switching power supply comprising the control circuit according to claim 1.

9. A mobile communication base station comprising the switching power supply according to claim 8.

10. A server comprising the switching power supply according to claim 8.
